(19) United States
(12) Patent Application Publication
(10) Pub. No.: US 2009/0291229 A1
(43) Pub. Date: Nov. 26, 2009

(54) METHOD AND APPARATUS FOR STEAM HEATING WITH DRYING OF SOLVENTS

(75) Inventors: Ben Wallace, Warroad, MN (US); Andrew Dignan, Warroad, MN (US); Jay Quaife, Warroad, MN (US)

Correspondence Address: SCHWEGMAN, LUNDBERG & WOESSNER, P.A., P.O. BOX 2938, MINNEAPOLIS, MN, 55402, US

(73) Assignee: Marvin Lumber and Cedar Company d/b/a Marvin Windows and Doors, Warroad, MN (US)

(21) Appl. No.: 12/433,507

(22) Filed: Apr. 30, 2009

Related U.S. Application Data
(60) Provisional application No. 61/049,285, filed on Apr. 30, 2008.

(51) Int. Cl. B05D 3/06; B05D 3/12; B05D 3/02; B05D 3/04

(52) U.S. Cl. 427/553; 427/351; 118/58; 118/643; 118/50

(57) ABSTRACT

A method for drying wood based materials includes applying a treatment including a first chemical, such as a solvent, to a wood based material. The wood based material is preheated using steam. At least part of an atmosphere is evacuated from around the wood based material. The wood based material is dried using heated using steam and is exposed to radiation to evaporate at least a portion of the first chemical.

### CROSS-REFERENCE TO RELATED APPLICATION

This application claims the priority of U.S. Ser. No. 61/049,285, filed Apr. 30, 2008, which is incorporated herein by reference in its entirety.

### TECHNICAL FIELD

Drying of wood based material and in particular drying to remove solvents therein with steam heating and electromagnetic irradiation energy.

### BACKGROUND

Many current window and door assemblies include treated materials, such as wood or wood composites. The materials are treated with a variety of chemicals suspended in carriers including water and solvents (e.g., mineral spirits). The chemicals contained in the treatments include preservatives, water repellants, fungicides, insecticides, dyes, pigments and the like. In some examples, the materials (e.g., window or door members) are submerged in the treatment where the treatment is absorbed along the surface of the materials. The materials are subsequently dried with heated ambient air in kilns or driers. The drying process evaporates the carriers leaving behind at least some of the chemicals. Because the treatment is applied only along the surface of the materials, the long term resistance of the materials to fungus, insects, water damage and the like is decreased as the treatment begins to break down.

### SUMMARY

A method includes introducing steam into a chamber and using the introduced steam to preheat a wood based material in the chamber, including adding moisture while the steam is introduced. The method further includes applying a treatment including a first chemical to the wood based material, evacuating at least part of an atmosphere from around the wood based material, and exposing the treated wood based material to radiation. In a further option, at least a portion of the first chemical is evaporated and at least a portion of the treatment remains with the wood based material.

In another embodiment, the method includes evacuating a chamber having a wood based material therein, and evacuating the chamber creates a vacuum in the chamber. The method further includes pre-heating the wood based material by introducing steam into the chamber, permeating the wood based material with a treatment including a first chemical, and the treatment penetrates beyond the surface of the wood based material, and exposing the treated wood based material to radiation. In a further option, at least a portion of the first chemical is evaporated and at least a portion of the treatment remains with the wood based material.

These and other options, embodiments, advantages, and features of the present invention will be set forth in part in the description which follows, and in part will become apparent to those skilled in the art by reference to the following description of the invention and referenced drawings or by practice of the invention. The embodiments of the invention are realized and attained by means of the instrumentalities, procedures, and combinations particularly pointed out in the appended claims and their equivalents.

### BRIEF DESCRIPTION OF THE DRAWINGS

FIG. 1 is a schematic diagram showing one example of an apparatus for drying a wood based material.

FIG. 2 is a block diagram illustrating one example of a method for drying a wood based material.

FIG. 3 is a block diagram illustrating another example of a method for drying a wood based material.

FIG. 4A is a perspective view of one example of a window assembly including treated wood based material.

FIG. 4B is a perspective view of one example of a window portion including treated wood based material.

FIG. 4C is a perspective view of another example of a window portion including treated wood based material.

FIG. 5 is a schematic diagram illustrating an apparatus for drying a wood based material in accordance with at least one embodiment.

FIG. 6 is a block diagram illustrating a method in accordance with at least one embodiment.

### DESCRIPTION OF THE EMBODIMENTS

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

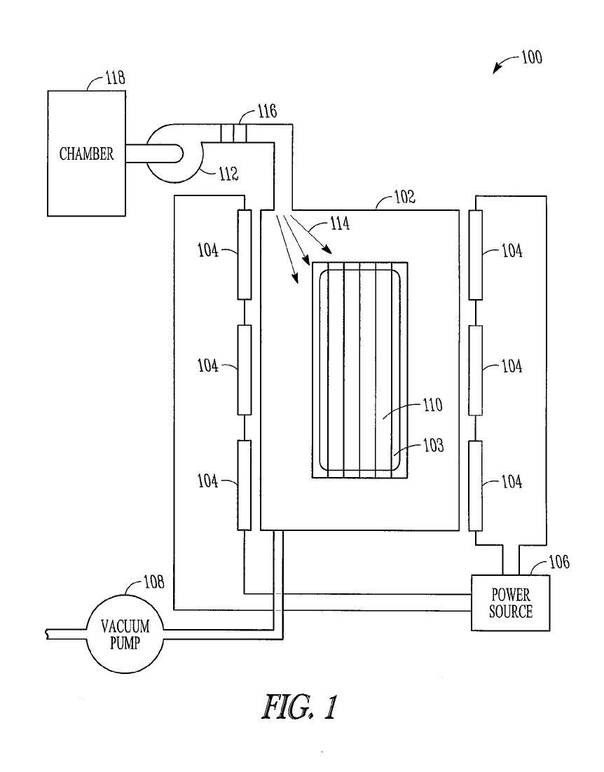

FIG. 1 shows an example of a drying assembly 100. The drying assembly includes at least one chamber 102. The at least one chamber 102 is sealable to isolate contents from the ambient atmosphere. The chamber 102 is dimensioned and configured to receive wood based materials 103 (e.g., a batch or bundle of wood components). The drying assembly 100 further includes a radiation source, such as, but not limited to, electromagnetic irradiation plates 104 electrically coupled with a power source 106. In one option, the electromagnetic irradiation plates 104 include plates adapted to produce radiation in the range of about three kHz to about 300 GHz and can include microwave radiation. In another option, the electromagnetic radiation is in the range of about 100 kHz to 18 GHz.

The electromagnetic irradiation plates 104 are arranged around the chamber 102 and provide an even distribution of electromagnetic radiation within the chamber 102, in yet another option. Optionally, the drying assembly 100 includes a vacuum pump 108 in communication with the chamber 102. The vacuum pump 108 operates to pump at least a portion of the atmosphere out of the chamber 102. The vacuum pump 108 optionally cooperates with the electromagnetic irradiation plates 104 to provide rapid drying of the wood based material 103. The vacuum pump 108 creates a low pressure environment around the wood based material 103 that facilitates evaporation of at least a first chemical (e.g., a solvent) in a treatment 110 in the wood based material 103. In a further option, the vacuum pump 108 can be used to pull a vacuum on the chamber.

The electromagnetic irradiation plates 104 heat the first chemical causing the first chemical to evaporate. A portion of the treatment, such as conditioning chemicals (e.g., fungicides, water repellants, dyes, pigments, insecticides, preservatives, adhesives and the like), are left behind with the wood based material 103. The conditioning chemicals are generally solids suspended or dissolved within the first chemical and thereby do not evaporate with the first chemical.

As shown in FIG. 1, the drying assembly 100 optionally includes a blower 112 in communication with the chamber 102. The blower 112 is dimensioned and configured to move a stream of gas 114 over the wood based material 103. In one option, the stream of gas 114 is humidified (e.g., up to about 95% relative humidity) and substantially prevents combustion of chemicals in the treatment 110, as described below. The stream of gas 114 is humidified with humidifiers 116 including, but not limited to, water injectors, such as steam injectors, water atomizers and the like. In another option, the blower 112 draws the stream of gas 114 from a separate chamber 118 having an environmentally controlled atmosphere including the predetermined humidity.

In another option, the stream of gas 114 is adapted to substantially prevent combustion of at least the first chemical. The first chemical includes a flammable solvent, in one option. Moving the humidified stream of gas over the wood based material 103 saturates the atmosphere around the material 103 and optionally minimizes the likelihood of combustion of the first chemical. In another option, the blower 112 moves a stream of incombustible gas (e.g., nitrogen, inert gases and the like) over the wood based material 103. The incombustible gas creates an incombustible environment around the wood based material 103 that substantially prevents combustion of the first chemical. In still another option, a vacuum (e.g., around about −28.5 in Hg) is retained around the wood based material 103 and held after application of radio frequency radiation. The vacuum prevents exposure of the material 103 to oxygen and thereby substantially prevents combustion. The vacuum is held until the wood based material cools sufficiently for exposure to the ambient atmosphere without combustion.

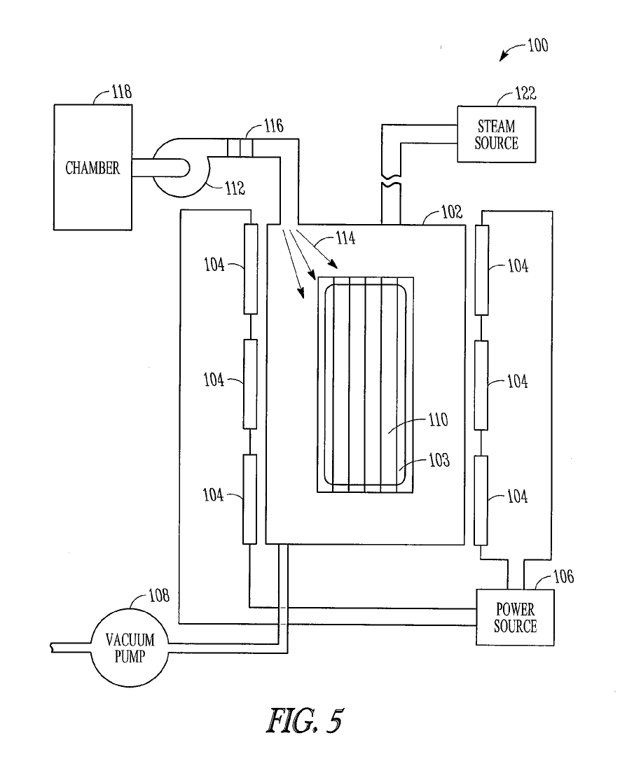

In a further option, as shown in FIG. 5, in addition to the components discussed above, the assembly 100 further includes a heating steam inlet 120. The heating steam inlet 120 is communicatively coupled with the chamber 120, and provides steam to the chamber 120. The heating steam inlet 120 is further coupled with a steam source 122. In an option, the steam source 122 is a low pressure steam source. In an option, the steam source 122 provides steam at 250 degrees F. In a further option, the steam source 122 provides steam at low pressure, such as less than 15 psi, less than 10 psi, or in the range of about 6-12 psi. It should be noted that other pressures for the steam can be used, including relatively higher pressures.

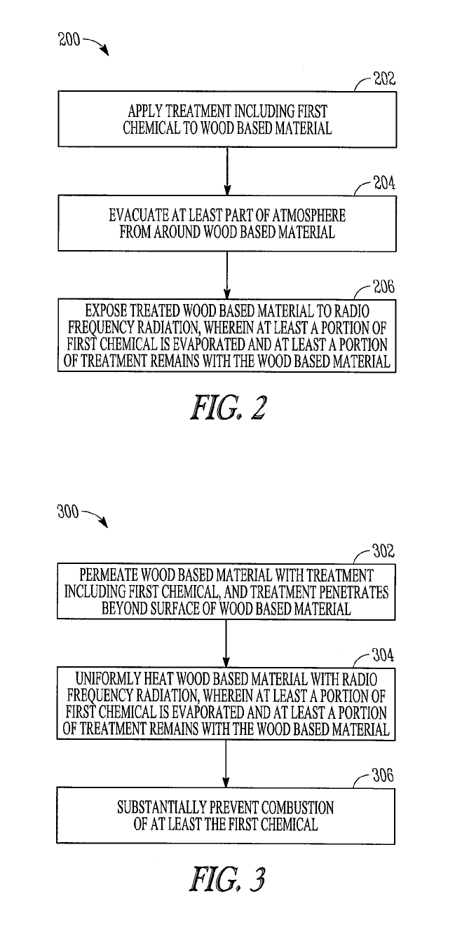

FIG. 2 illustrates one example of a method 200 for producing a wood based material, such as treated woods or wood composites, for instance, sheets, boards, beams and the like. The wood based material is used in the construction of window and door assemblies, in one option. The wood based material includes wood of at least one variety (e.g., pine, mahogany, Douglas fir, oak or combinations thereof). In another option, the wood based material includes wood composite such as wood laminate, panel wood composite, oriented strand board (OSB), veneer based wood composite (e.g., pultruded veneer composite and laminated veneer lumber (LVL)) or combinations thereof.

At 202, a treatment including a first chemical is applied to the wood based material. The first chemical of the treatment of method 200 optionally includes a solvent such as, but not limited to mineral spirits, naptha, ketones, alcohols, Stoddard solvents, hydrocarbon solvents or combinations thereof. In an option, the first chemical serves as a carrier for conditioning chemicals in the treatment that provide desirable properties to the wood based material. In one option, the conditioning chemicals include, but are not limited to, fungicides, water repellants, dyes, pigments, insecticides, preservatives, adhesives and the like. In the method 200, the conditioning chemicals are suspended in the first chemical (e.g., a solvent) and brought into contact with the wood based material, for instance, by submerging the wood based material in the treatment. Once exposed to the treatment, the wood based material takes up at least some of the conditioning chemicals. In an option, the treatment is applied in the chamber where the steam is introduced. In another option, the treatment occurs in a separate location, such as a separate chamber.

In one option, the treatment is applied to the wood based material, for example, a batch or bundle of wood components, by submerging the components in a vessel containing the treatment. In another option, the wood based material is sealed within a chamber and exposed to a vacuum. The vacuum substantially removes gases such as air disposed within pores of the wood based material. The chamber is then flooded with the treatment and the first chemical brings the conditioning chemicals into contact with the wood based material. Because the pores of the wood based material are substantially free of gases, the treatment (i.e., the first chemical carrier and the conditioning chemicals suspended therein) deeply penetrates the wood based material. In another option, the vacuum is released thereby allowing reintroduction of the atmosphere. The atmospheric pressure pushes the treatment in the vessel all around the wood based material. The pressure pushes the treatment further into the wood based material ensuring deeper treatment. In yet another option, the vacuum is released and the wood based material is subjected to pressure above that of the ambient atmosphere to further enhance penetration of the treatment.

In another option, a vacuum is not applied prior to the flooding of the vessel and exposure of the wood based material to the treatment. Pockets of air thereby remain within the pores of the wood based material. Optionally, pressure is applied around the treatment to drive the treatment into the air filled pores. The pressurization is released, in yet another option, allowing the air within the pores to expand and forcing the treatment out. A portion of the treatment including the conditioning chemicals and some of the first chemical (e.g., the solvent) is left behind. A vacuum is applied, in still another option, to further draw out the treatment. Allowing air to remain in the pores allows the extraction of conditioning chemicals and solvents that are potent and therefore require lesser amounts to condition the wood based material. Additionally, extraction of the treatment is performed with wood based materials used in low risk applications (e.g., indoors, dry environments and the like) where intense treatment is not needed.

The wood based material is exposed to the treatment for a predetermined amount of time to sufficiently penetrate the material and ensure absorption of the conditioning chemicals (e.g., fungicides, water repellants, dyes, pigments, insecticides, preservatives and the like). The period for treating the wood based material is, in an option, based upon the wood used in the wood based material, the conditioning chemicals, the desired penetration of the conditioning chemicals and the method of treatment application to the wood based material (e.g., submerging, evacuation of air prior to flooding, pressurization of the treatment and the like). In one example, the wood based material is exposed to the treatment between around 5 seconds to 5 minutes or more in a submerging process. In another example, with a vacuum treating process (described above), the wood based material is exposed to the treatment between around 10 minutes to 1 hour. With pressure treatments, in yet another example, the wood based material is treated for around 10 minutes to 12 hours.

The remaining treatment surrounding the wood based material is drained after the material is sufficiently treated. In one option a vacuum is applied to the drained chamber containing the wood based material. The vacuum operates to draw out excess treatment within the pores of the wood based material that is not necessary for conditioning of the material.

At 204, at least a portion of the atmosphere is evacuated from around the wood based material. Evacuating the atmosphere provides a low pressure environment (e.g., around about −28.5 in Hg) that facilitates rapid drying of the wood based material. The low pressures allow the first chemical to easily evaporate from the wood based material, thereby greatly expediting the drying process. In one option, the vacuum is retained around the wood based material.

At 206, the wood based material is exposed to electromagnetic radiation. The frequencies used to dry the treated wood based material have a range from about three kilohertz to about 300 gigahertz and include microwave radiation. In one option, the wood based material is exposed to electromagnetic radiation in the range of about 100 kilohertz to 18 gigahertz. The electromagnetic radiation evaporates at least a portion of the first chemical (e.g., the solvent). At least a portion of the treatment (i.e., at least some of the conditioning chemicals) remain with the wood based material. In one example, the electromagnetic radiation removes substantially all of the first chemical, while a negligible amount of the conditioning chemicals (i.e., about one percent or less) are evaporated. The electromagnetic radiation facilitates consistent uniform heating of the wood based material. For instance, the radiation heats a wood based component throughout the component (i.e., inside and outside) and/or all of the components in a batch or bundle stacked together within a drying assembly. The electromagnetic radiation is applied according to, but not limited to, a preset drying schedule, the first chemical concentration in the wood based material or in the atmosphere around the material, the temperature of the wood based material or of the atmosphere around the material, and the like. In one option, application of the electromagnetic radiation is discontinued at a particular chemical concentration and/or at a particular temperature. For example, application of electromagnetic radiation is discontinued when 70 to 99 percent of the solvent has been removed from the wood based material. The percentage removal of the solvent is determined, in another option, by measuring the content of the vaporized solvent in exhaust gases from the irradiated wood based material. In another example, the electromagnetic radiation is discontinued at a predetermined temperature in the range of about 120 to 170 degrees F. Optionally, application of the radiation is cyclically applied to maintain this temperature, as described below. Discontinuing drying after reaching prescribed temperatures and/or chemical concentrations saves time and manufacturing costs by precluding unnecessary drying.

In one option, the vacuum in step 204 is retained around the wood based material while the material is exposed to the electromagnetic radiation. As described above, the low pressure environment provided by the vacuum enhances the evaporation of the first chemical. In another option, the vacuum and the electromagnetic radiation cooperate to rapidly evaporate the first chemical and dry the wood based material with the absorbed conditioning chemicals retained therein.

Optionally, the wood based material is cyclically exposed to the electromagnetic radiation and a vacuum. For example, the wood based material is exposed to a vacuum that is then released. The low pressure atmosphere created by the vacuum allows at least some of the first chemical to evaporate. The wood based material is then exposed to electromagnetic radiation for a period of time to evaporate more of the first chemical. In one option, the pattern continues with additional cycles of alternating vacuum and electromagnetic exposure to progressively evaporate more of the first chemical. For example, a treated wood based window portion, such as a sash member, is exposed to electromagnetic radiation for around 5 minutes, then a vacuum of around −28.5 in Hg is drawn around the sash member and held for around 20 minutes. In another example, the cycle repeats at least twice more. In still another example, after exposure to electromagnetic radiation, a vacuum of around −28.5 in Hg is drawn and immediately released and then drawn again and immediately released. This process continues for around 20 minutes, in yet another example. Another pattern uses cycles of electromagnetic radiation exposure that occur contemporaneously with application of a vacuum to the material. In another option, the wood based material is exposed to a series of intermittent (e.g., irregular interval) electromagnetic radiation treatments that are optionally preceded or followed by exposure to vacuum. Electromagnetic radiation is applied intermittently according to, but not limited to, a preset drying schedule, the first chemical concentration in the wood based material or in the atmosphere around the material, the temperature of the wood based material or of the atmosphere around the material, and the like. Optionally, the wood based material is exposed to intermittent and/or lower energy electromagnetic radiation to evaporate at least a portion of the first chemical without breaking down conditioning chemicals otherwise subject to damage from long term and/or high energy exposure to electromagnetic radiation. Additionally, intermittent and/or lower energy exposure of the wood based material to electromagnetic radiation ensures the material is not burnt or damaged by the radiation.

In another option, the wood based material is exposed to a stream of humidified gas. In one option, the humidified gas has between around 30 and 95 percent relative humidity and substantially prevents combustion of at least the first chemical. In one option, the stream of gas is humidified with, but not limited to, water injectors, such as, steam injectors, water atomizers and the like. In another option, the stream of gas is drawn from an environmentally controlled chamber containing the humidified gas.

In yet another option, the wood based material is exposed to the stream of humidified gas at the same time the material is exposed to electromagnetic radiation. In another option, the material is exposed to the humidified gas before or after exposing the material to the electromagnetic radiation. Where the wood based material is exposed to a vacuum the humidified gas is bled into a chamber surrounding the material, in still another option. Optionally, the humidified gas is bled into the chamber including the wood based material while the material is under a vacuum and exposed to electromagnetic radiation. The humidified gas is introduced into the chamber after drying and release of the vacuum, in yet another option.

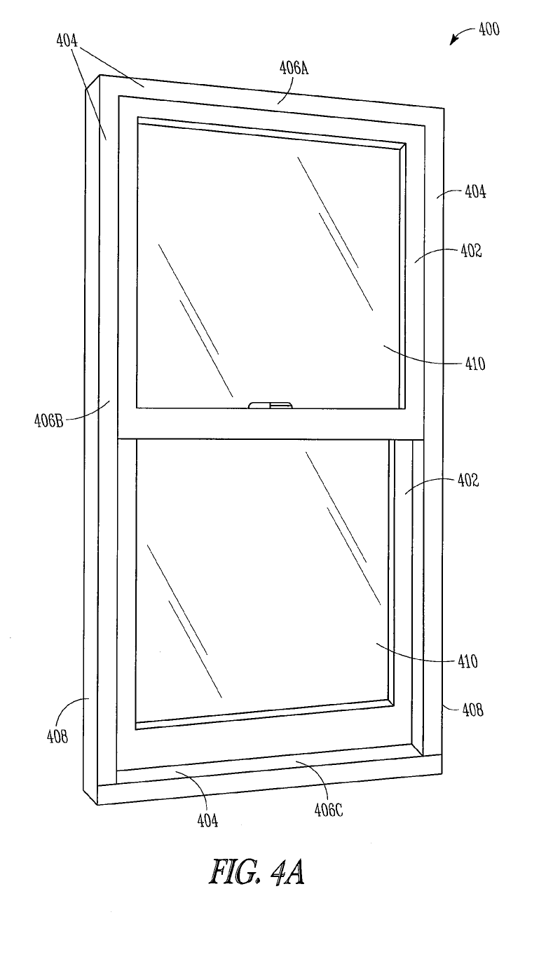

FIG. 3, shows another example of a method 300 for drying a wood based material (i.e., wood, wood composites and the like). At 302, the wood based material is permeated with a treatment including a first chemical that penetrates beyond the surface of the material. As described above, the treatment is introduced into the wood based material by exerting pressure on the treatment to force it into the pores of the material. In one example, a vacuum is drawn around the wood based material and the treatment is then introduced. The treatment and the material are pressurized (i.e., atmospheric pressure or greater) to force the treatment solution into the pores of the wood based material. In another example, the wood based material is exposed to the treatment without a vacuum and then pressurized above atmospheric pressure to force the treatment into the pores.

At 304, the wood based material is uniformly heated with electromagnetic radiation. The electromagnetic irradiation heating evaporates at least a portion of a first chemical (e.g., a solvent carrier) in the treatment while at least a portion of the treatment remains (i.e., conditioning chemicals) with the wood based material. The electromagnetic radiation facilitates consistent uniform heating of the wood based material. For instance, the radiation heats a wood based component throughout the component (i.e., inside and outside) and/or all of the components in a batch or bundle stacked together within a drying assembly, for example, drying assembly 100 (FIG. 1). The electromagnetic radiation is applied according to, but not limited to, a preset drying schedule, the first chemical concentration in the wood based material or in the atmosphere around the material, the temperature of the wood based material or of the atmosphere around the material, and the like. In one option, application of the electromagnetic radiation is discontinued at a particular chemical concentration and/or at a particular temperature.

As described above, in one option, a vacuum (e.g., around about −28.5 in Hg) is created around the wood based material to assist in drying of the material. The vacuum creates a low pressure environment that allows fluids, such as solvents, to easily evaporate when heated with electromagnetic radiation. The vacuum and electromagnetic radiation cooperate to rapidly dry the wood based material thereby decreasing drying times and saving manufacturing costs. In one option, the vacuum is retained around the wood based material while the material is exposed to the electromagnetic radiation.

Optionally, the wood based material is cyclically exposed to the electromagnetic radiation and a vacuum. For example, the wood based material is exposed to a vacuum that is then released. The low pressure atmosphere created by the vacuum allows at least some of the first chemical to evaporate. The wood based material is then exposed to electromagnetic radiation for a period of time to evaporate more of the first chemical. In one option, the pattern continues with additional cycles of alternating vacuum and electromagnetic irradiation exposure to progressively evaporate more of the first chemical. For example, a treated wood based window portion, such as a sash member, is exposed to electromagnetic radiation for around 5 minutes, then a vacuum of around −28.5 in Hg is drawn around the sash member and held for around 20 minutes. In another example, the cycle repeats. In still another example, a vacuum of around −28.5 in Hg is drawn and immediately released and then drawn again and immediately released. Another pattern uses cycles of electromagnetic radiation exposure that occur contemporaneously with application of a vacuum to the material. Yet another pattern exposes the wood based material to a continuous vacuum and cycled electromagnetic irradiation (e.g., around 15 second to 30 minute cycles). A vacuum is cycled (e.g., for multiple periods between around 1 minute and 90 minutes) with either cycled or continuous electromagnetic radiation. Still another pattern exposes the wood based material to a variety of vacuum pressures, for instance, cycling between a strong vacuum of between around −20 in Hg to −29 in Hg and a weak vacuum of between around 0 in Hg to −20 in Hg with either continuous or cycled electromagnetic energy.

In another option, the wood based material is exposed to a series of intermittent (e.g., irregular interval) electromagnetic radiation treatments that are optionally preceded or followed by exposure to vacuum. Electromagnetic radiation is applied intermittently according to, but not limited to, a preset drying schedule, the first chemical concentration in the wood based material or in the atmosphere around the material, the temperature of the wood based material or of the atmosphere around the material, and the like. Optionally, the wood based material is exposed to intermittent and/or lower energy electromagnetic radiation to evaporate at least a portion of the first chemical without breaking down conditioning chemicals otherwise subject to damage from long term and/or high energy exposure to electromagnetic radiation. Additionally, intermittent and/or lower energy exposure of the wood based material to electromagnetic radiation ensures the material is not burnt or damaged by the radiation. The wood based material, in yet another option, is exposed to a continuous vacuum with continuous lower energy electromagnetic radiation.

The method 300 further includes, at 306, substantially preventing combustion of at least the first chemical. The first chemical is a flammable solvent, in one option. The method 300 optionally exposes the wood based material including the treatment with a flammable solvent to a stream of gas adapted to substantially prevent combustion of at least the first chemical. The stream of gas includes a controlled humidified gas, as described above, in one option. The humidity of the stream of gas (e.g., around about 30 to about 100% relative humidity) retards and substantially prevents combustion of the first chemical, and thereby allows rapid drying with electromagnetic irradiation to continue. In another option, the stream of gas includes a gas including, but not limited to, nitrogen, an inert gas (e.g., argon, xenon) and the like. The gas is incombustible. When the wood based material is exposed to the gas, combustion of the first chemical (e.g., a solvent) is substantially prevented. The stream of gas is introduced to the wood based material, in yet another option, while drying the material with electromagnetic radiation. Optionally, the stream of gas is bled into a chamber containing the material that is under vacuum. The stream of gas is introduced when the vacuum is released near the end of drying, in still another option. The wood based material may still be hot from the drying process and the gas is introduced to prevent combustion when the vacuum is released.

In another option, the vacuum is retained around the wood based material after drying with electromagnetic radiation has evaporated the desired portion of the first chemical (e.g., a solvent). The vacuum substantially prevents oxygen from reaching the wood based material and thereby prevents combustion. The vacuum is held until the wood based material sufficiently cools for exposure to ambient atmosphere without combustion.

Waste gases are generated by drying the wood based material. The waste gases include moisture, solvents and the like evaporated from the wood based material. The waste gases are optionally vented to the atmosphere. In one option, the waste gases are fed through a condenser that condenses out at least one of the moisture, solvents and the like. In another option, the waste gases are further treated with carbon media, bio-filters and emissions controls. The cleaned gas is then reused during drying as described above, in another option. In yet another option, the cleaned gas is harmlessly vented into the atmosphere.

Optionally, finishing operations are performed on the wood based material. In one option, finishing operations include cutting, staining, sealing and the like. The finishing operations, in another option, place the wood based material in proper form for storage and/or assembly into door and window assemblies.

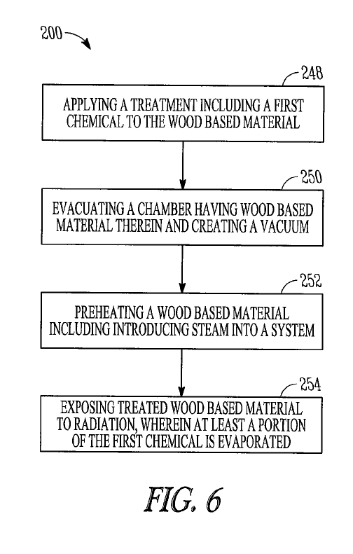

FIG. 6, illustrates another example of a method for drying a wood based material (i.e., wood, wood composites and the like). The method can include the various options discussed above. In a further option, at 248, a treatment is applied including a first chemical to the wood based material. In an option, the wood based material is permeated with a treatment including a first chemical that penetrates beyond the surface of the material. As described above, the treatment is introduced into the wood based material by exerting pressure on the treatment to force it into the pores of the material. In one example, a vacuum is drawn around the wood based material and the treatment is then introduced. The treatment and the material are pressurized (i.e., atmospheric pressure or greater) to force the treatment solution into the pores of the wood based material. In another example, the wood based material is exposed to the treatment without a vacuum and then pressurized above atmospheric pressure to force the treatment into the pores.

Further options for the method include evacuating a chamber having wood based material therein, 250. In an option, a vacuum is created in the chamber by the evacuation, and for example, oxygen in the chamber is eliminated. Steam is introduced into the chamber, and the wood based material is preheated by the steam, 252. In an option, the steam releases the vacuum on the chamber as the steam is introduced into the chamber, and the steam results in significantly lower oxygen content. In a further option, the preheating includes blowing steam into the chamber. The heating can be done, for example, without RF energy, which saves time and energy. The steam heating allows for a way to safely heat, for example, in the presence of combustible and/or flammable materials or chemicals.

The steam is introduced into a chamber, for example, with a two inch steam port. In an option, steam with minimal liquid is used to minimize moisture uptake. The steam inlet is coupled with a steam source. For instance, in an option, the steam source provides low pressure steam such as less than 15 psi. In another option, the steam is less than about 10 psi. In another option, the steam is in the range of about 6-12 psi. In yet another option, the steam is at about 250 degrees F. It should be noted that other pressures for the steam can be used, including relatively higher pressures.

The method further includes exposing the treated wood based material to radiation, where at least a portion of the first chemical is evaporated, 254. In an option, a portion of the treatment, such as the chemical, remains with the wood based material. For example, the wood based material is uniformly heated with electromagnetic radiation. Other types of radiation are possible The electromagnetic irradiation heating evaporates at least a portion of a first chemical (e.g., a solvent carrier) in the treatment while at least a portion of the treatment remains (i.e., conditioning chemicals) with the wood based material. The electromagnetic radiation facilitates consistent uniform heating of the wood based material. For instance, the radiation heats a wood based component throughout the component (i.e., inside and outside) and/or all of the components in a batch or bundle stacked together within a drying assembly, for example, drying assembly 100 (FIG. 1). The electromagnetic radiation is applied according to, but not limited to, a preset drying schedule, the first chemical concentration in the wood based material or in the atmosphere around the material, the temperature of the wood based material or of the atmosphere around the material, and the like. In one option, application of the electromagnetic radiation is discontinued at a particular chemical concentration and/or at a particular temperature.

As described above, in one option, a vacuum (e.g., around about −28.5 in Hg) is created around the wood based material to assist in drying of the material. The vacuum creates a low pressure environment that allows fluids, such as solvents, to easily evaporate when heated with electromagnetic radiation. The vacuum and electromagnetic radiation cooperate to rapidly dry the wood based material thereby decreasing drying times and saving manufacturing costs. In one option, the vacuum is retained around the wood based material while the material is exposed to the electromagnetic radiation.

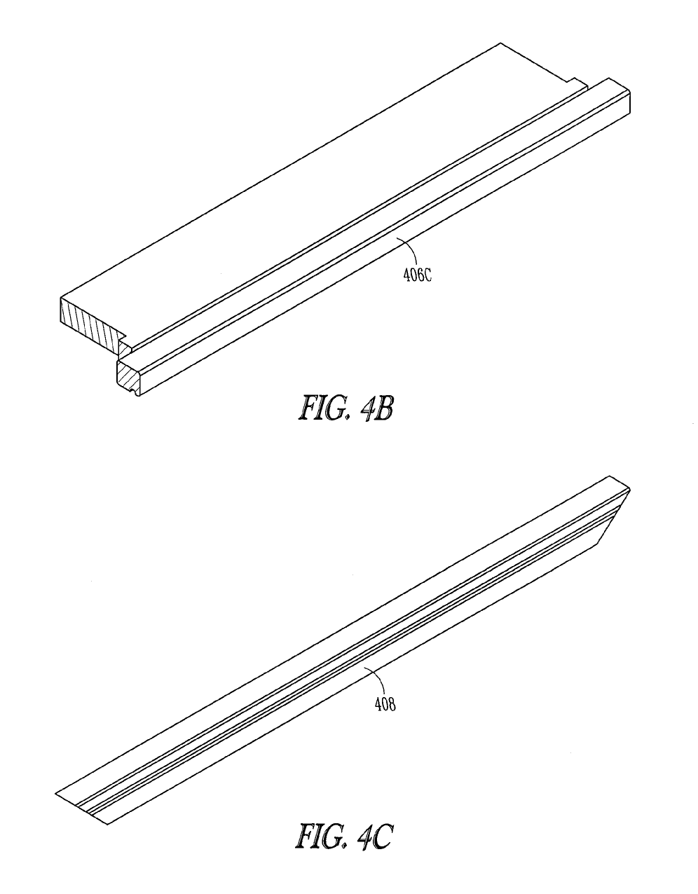

FIGS. 4A-C illustrate examples of wood based material products or assemblies including wood based material formed, for instance, with the methods and assembly described above. An example of a window assembly 400 is shown in FIG. 4A. In one option, the window assembly 400 includes sashes 402 dimensioned and configured to couple with the frame 404 of the window assembly 400. The sashes 402 optionally move within the frame 404 and include glass panes 410. In another option, the frame 404 includes a head portion 406A, jamb portions 406B and a sill portion 406C. The frame 404 further includes, in yet another option, casing 408 extending around the portions 406A-C. Any portion of the window assembly 400 (e.g., the sashes 402, portions 406A-C, casing 408 and the like) is constructed with wood based materials that are produced by treating the materials with at least a first chemical and drying the materials to evaporate the first chemical.

In one option, the sill portion 406C (FIG. 4B) includes wood based material that is treated and dried, as described above. FIG. 4C shows a portion of the casing 408 that surrounds the window assembly 400 (FIG. 4A). In another option, the casing 408 includes a wood based material that is produced (e.g., by treating and drying) as described above. Additionally, in yet another option, door assemblies, shutters, siding and the like are constructed with wood based materials produced by treating with a first chemical and drying the material of the first chemical, as described above.

The above described method for drying a wood based material provides improved drying of treated wood based materials, including materials that are deeply penetrated with a treatment (e.g., through vacuum and pressurizing processes). The wood based material is dried with electromagnetic radiation that uniformly heats the material. In one option, the wood based material includes a batch or bundle of wood or wood composite components. Batches or bundles of components and deeply treated material are rapidly dried because electromagnetic radiation uniformly heats on the surface and inside the material. Drying treated wood based materials with electromagnetic radiation decreases drying times and manufacturing costs.

The electromagnetic radiation evaporates a first chemical (e.g., a solvent) used to carry conditioning chemicals while leaving the conditioning chemicals with the wood based material. Optionally, drying with electromagnetic radiation is paired with evacuation of the atmosphere around the wood based material. The vacuum creates a low pressure environment that facilitates enhanced evaporation of chemicals in the treatment. Electromagnetic irradiation cooperates with the vacuum to further expedite the drying process by heating the wood based material in the low pressures created with the vacuum.

In another option, the electromagnetic radiation is applied according to a preset drying schedule, temperature, concentration of a chemical (e.g., a solvent) or the like. Drying with the electromagnetic radiation is stopped, optionally, when a predetermined temperature is reached, for instance the temperature of the wood based material, the temperature of the material, and the like. The predetermined temperature indicates that the drying has evaporated the chemicals, such as solvents, and left behind the conditioning chemicals with the wood based material. In yet another option, application of the electromagnetic radiation is discontinued when a particular chemical concentration (e.g., the concentration of a solvent) is detected in the wood based material or in the atmosphere around the material. Discontinuing drying in this manner saves time and cost by precluding unnecessary drying after a chemical has been removed from the wood based material. Additionally, electromagnetic radiation is intermittently applied to the wood based material in a similar manner (e.g., according to a preset drying schedule, temperature, concentration of a chemical and the like). Intermittently exposing the wood based material to the electromagnetic radiation, in one option, assists evaporation of the first chemical without damaging other components of the treatment, for instance, conditioning chemicals. The intermittent exposure prevents the breakdown of the conditioning chemicals and thereby maintains the efficacy of the chemicals. Further, intermittent electromagnetic irradiation heating assists in preventing burning of the wood based material during drying.

The above description is intended to be illustrative, and not restrictive. For example, the above-described examples (or one or more features thereof) can be used in combination with each other. Other embodiments can be used, such as by one of ordinary skill in the art upon reviewing the above description. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

The Abstract is provided to comply with 37 C.F.R. §1.72(b), to allow the reader to quickly ascertain the nature of the technical disclosure. It is submitted with the understanding that it will not be used to interpret or limit the scope or meaning of the claims.

What is claimed is:

1. A method comprising:
permeating the wood based material with a treatment including a first chemical, and the treatment penetrates beyond the surface of the wood based material;
disposing the wood based material within a chamber;
evacuating the chamber having a wood based material therein, and evacuating the chamber creates a vacuum in the chamber; and
pre-heating the wood based material by introducing steam into the chamber.

2. The method as recited in claim 1, wherein introducing steam into the chamber releases the vacuum of the chamber.

3. The method as recited in claim 1, wherein disposing the wood based material into the chamber is after permeating the wood based material with the treatment.

4. The method as recited in claim 1, further comprising exposing the treated wood based material to radiation, wherein at least a portion of the first chemical is evaporated and at least a portion of the treatment remains with the wood based material.

5. The method as recited in claim 1, wherein exposing the treated wood based material to radiation includes evaporating at least a portion of the first chemical including a solvent.

6. The method as recited in claim 1, wherein introducing steam includes blowing steam into the chamber.

7. The method as recited in claim 1, wherein introducing steam includes introducing low pressure steam of about 6-12 psi.

8. The method as recited in claim 1, wherein introducing steam includes introducing low pressure steam of about 10 psi.

9. The method as recited in claim 1, wherein introducing steam includes introducing low pressure steam of less than about 15 psi.

10. The method as recited in claim 8, wherein introducing steam includes introducing steam at about 250 degrees F.

11. A method comprising:
applying a treatment including a first chemical to a wood based material;
evacuating at least part of an atmosphere from around the wood based material;
introducing steam into a chamber and using the introduced steam to preheat the wood based material in the chamber, including adding moisture while the steam is introduced; and
exposing the treated wood based material to radiation.

12. The method as recited in claim 11, wherein evacuating the chamber creates a vacuum prior to introducing the steam into the chamber.

13. The method as recited in claim 11, wherein introducing steam includes introducing low pressure steam of about 6-12 psi.

14. The method as recited in claim 11, wherein introducing steam includes introducing low pressure steam of about 10 psi.

15. The method as recited in claim 11, wherein introducing steam includes introducing low pressure steam of less than about 15 psi.

16. The method as recited in claim 11, wherein introducing steam includes blowing steam into the chamber.

17. The method as recited in claim 11, wherein introducing steam into the chamber releases the vacuum of the chamber.

18. An apparatus comprising:
at least one chamber sized and shaped to receive a wood based material;
at least one heating steam inlet communicatively coupled with the chamber;
wood based material dryer coupled to the at least one chamber, wherein the wood based material includes a treatment having at least a first chemical, and the dryer evaporates at least the first chemical and leaves a portion of the treatment with the wood based material.

19. The apparatus as recited in claim 18, wherein the wood based material dryer includes one or more electromagnetic irradiation plates configured to expose the wood based material to electromagnetic radiation.

20. The apparatus as recited in claim 18, wherein the wood based material dryer includes a pump coupled to the at least one chamber, wherein the pump is configured to evacuate at least part of an atmosphere from around the wood based material.
